(19) United States
(12) Patent Application Publication
(10) Pub. No.: US 2018/0341967 A1
(43) Pub. Date: Nov. 29, 2018

(54) PRODUCT SALES PROMOTION SYSTEM AND METHOD USING SALES PROFIT DISTRIBUTION IN ACCORDANCE WITH EVENT'S SUCCESS

(71) Applicant: SV INC., Seoul (KR)

(72) Inventors: Yong Hyun KANG, Suwon-si (KR); Du Hyun Kim, Seoul (KR)

(21) Appl. No.: 16/055,276

(22) Filed: Aug. 6, 2018

Related U.S. Application Data
(63) Continuation-in-part of application No. PCT/KR2017/000764, filed on Jan. 23, 2017.

(30) Foreign Application Priority Data
Feb. 6, 2016 (KR) 10-2016-0015339
May 9, 2016 (KR) 10-2016-0056701

(51) Int. Cl. G06Q 30/02

(52) U.S. Cl. CPC G06Q 30/0215; G06Q 30/0234; G06Q 30/0211; G06Q 30/0238

(57) ABSTRACT

The disclosed technology includes: an event configuration unit receiving sales price of a product, a target period of time for product sales and a target amount of product sales from a seller, to set an event which is successful when the target amount of product sales is reached within the target period, and to receive an amount of a distribution profit to be distributed when the event is successful, a distribution way of the distribution profit, and a distribution rate of the distribution profit from the seller; a product payment unit receiving a payment for the sales price of the product from a terminal of the purchaser; an event management unit activating the event and to check whether the number of payments reaches the target amount of product sales; and a profit distribution unit paying the distribution profit to the purchaser when the event is successful.

### CROSS-REFERENCE TO RELATED APPLICATION

The present application is a continuation-in-part of PCT Application No. PCT/KR2017/000764, filed on Jan. 23, 2017, which claims priority of Korean Patent Application No. 10-2016-0015339 filed on Feb. 6, 2016 and Korean Patent Application No. 10-2016-0056701 filed on May 9, 2016. The contents of these applications are incorporated herein by reference in their entirety.

### BACKGROUND

### (a) Technical Field

An aspect of the disclosed technology relates to an E-commerce system and method using a financial technology. Particularly, an aspect of the disclosed technology relates to a product sales promotion system and method using distribution of sales profit according to event success.

### (b) Description of the Related Art

E-commerce is the activity of buying or selling of products on online services or over the Internet. Recently, the E-commerce becomes to prevail the conventional off-line commerce, and therefore the technology advancing the E-commerce becomes more and more important.

A consumption behavior in a conventional economic system is carried out by paying for a product in cash and thus obtaining the product. Under such a structure, if large consumption is made, the cash assets of a consumer are just reduced, so that the consumer has to cut down his or her consumption so as to increase or maintain his or her cash assets.

If an economic depression occurs, accordingly, the consumer lowers his or her consumption, and thus, product sales are reduced. Subsequently, product sellers reduce the number of workers or their wage due to the decrement of their sales, and therefore, the consumer's income becomes reduced, so that he or she reduces the consumption more and more, thereby making such a vicious circle to be repeated under such a structure.

If the cash assets of the consumer are increased in related to his or her consumption, the phenomena will be reversed. In detail, the consumer increases his or her consumption more, and accordingly, product sales are drastically increased. Also, the product sellers increase the number of workers or their wage through the drastic increment of their sales and, in turns, the consumer's increased income promotes his or her consumption, so that if such an economic system is achieved, the world economy will be in the boom years.

Therefore, it will be a significant advance in the E-commerce if a new promoting technology providing a financial system wherein the cash assets of the consumer are increased in accordance with his or her consumption.

### SUMMARY

Various embodiments are provided to introduce a unique manner of product sales promotion system and method that distributes a portion of sales profit to purchasers under the condition that a product selling event defined by a seller is successful to increase the cash assets of the purchasers, so that the product sales are promoted.

The aspect of the product sales promotion system and method disclosed herein is not limited to the content as mentioned above, and other aspects not mentioned herein could be understood by the ordinary person in the art from the description below.

A product sales promotion system according to an embodiment of the disclosed technology may include: an event configuration unit adapted to receive at least one of sales price of a product, a target period of time for product sales, a target amount of product sales from a terminal of a seller, to set an event which is decided to be successful when the target amount of product sales is reached within the target period of time according to an input from the terminal of the seller, and to receive at least one of an amount of a distribution profit to be distributed to a purchaser when the event is successful, a distribution way of the distribution profit, and a distribution rate of the distribution profit from the terminal of the seller; a product payment unit adapted to receive a payment for the sales price of the product from a terminal of the purchaser; an event management unit adapted to activate the event and to check whether the number of payments for the sales price of the product received by the product payment unit reaches the target amount of product sales; and a profit distribution unit adapted to pay the distribution profit to the purchaser when the event management unit decides that the event is successful.

Before the event is activated, the event management unit may transmit an event notification message for notifying a start date and a start time of the event activation to a terminal of a member joined in the product sales promotion system.

The event management unit may activate the event after a predetermined standby period from a start time of the event activation.

The product sales promotion system may further include: a system account unit adapted to deposit the amount given by the payments; and a member account unit allocated to the member joined in the product sales promotion system, the member account unit adapted to deposit at least one of cyber money and cash.

Before or at the same time as the event activation starts, an event deposit of the seller which is the same amount as the distribution profit may be transferred from the member account unit of the seller to the system account unit.

The product sales promotion system may further include a delivery management unit adapted to transmit a delivery address of the purchaser to the terminal of the seller.

The product sales promotion system may further include a purchase confirmation management unit adapted to transmit a purchase confirmation request to the terminal of the purchaser and to receive a response to the purchase confirmation request from the terminal of the purchaser, wherein when the response to the purchase confirmation request is a purchase cancel response, the profit distribution unit transfers an amount corresponding to the sales price to the member account unit of the purchaser.

The product sales promotion system may further include a purchase confirmation management unit adapted to transmit a purchase confirmation request to the terminal of the purchaser and to receive a response to the purchase confirmation request from the terminal of the purchaser, wherein when the purchase confirmation management unit receives a purchase confirmation response and the event management unit decides that the event is successful, the profit distribution unit determines an individual distribution profit to be distributed to a purchaser who transmits the purchase confirmation response (hereinafter, referred to as “purchase confirmation purchaser”) by applying the distribution way of the distribution profit and the distribution rate of the distribution profit to the distribution profit, and the profit distribution unit transfers the individual distribution profit from an amount kept in the system account unit to the member account unit of the purchase confirmation purchaser.

The distribution way of the distribution profit may include: arranging the purchase confirmation purchasers in an order of payment; paying a first individual distribution profit calculated by multiplying the distribution profit by the distribution rate of the distribution profit to a first purchase confirmation purchaser who performs an earliest payment among the purchase confirmation purchasers; and paying a second individual distribution profit calculated by multiplying an amount remained after subtracting the first individual distribution profit from the distribution profit by the distribution rate of the distribution profit to a second purchase confirmation purchaser who performs a second earliest payment among the purchase confirmation purchasers.

The member account unit may include a cyber money account into which cyber money is deposited, and the distribution way of the distribution profit may include: arranging the purchase confirmation purchasers in an order of cyber money amount deposited into the cyber money account of the purchase confirmation purchaser; paying a first individual distribution profit calculated by multiplying the distribution profit by the distribution rate of the distribution profit to a first purchase confirmation purchaser who has a largest cyber money amount among the purchase confirmation purchasers; and paying a second individual distribution profit calculated by multiplying an amount remained after subtracting the first individual distribution profit from the distribution profit by the distribution rate of the distribution profit to a second purchase confirmation purchaser who has a second largest cyber money amount among the purchase confirmation purchasers.

The member account unit may include a cyber money account into which cyber money is deposited, and the distribution way of the distribution profit may include: arranging the purchase confirmation purchasers in an order of a value calculated by multiplying the cyber money amount of the cyber money account of the purchase confirmation purchaser by the number of the payments of the purchase confirmation purchaser (hereinafter, referred to as “multiplied value for order”); paying a first individual distribution profit calculated by multiplying the distribution profit by the distribution rate of the distribution profit to a first purchase confirmation purchaser who has a largest multiplied value for order among the purchase confirmation purchasers; and paying a second individual distribution profit calculated by multiplying an amount remained after subtracting the first individual distribution profit from the distribution profit by the distribution rate of the distribution profit to a second purchase confirmation purchaser who has a second largest multiplied value for order among the purchase confirmation purchasers.

The distribution way of the distribution profit may include: arranging the purchase confirmation purchasers in the order of purchase confirmation response; paying a first individual distribution profit calculated by multiplying the distribution profit by the distribution rate of the distribution profit to a first purchase confirmation purchaser who transmits an earliest purchase confirmation response among the purchase confirmation purchasers; and paying a second individual distribution profit calculated by multiplying an amount remained after subtracting the first individual distribution profit from the distribution profit by the distribution rate of the distribution profit to a second purchase confirmation purchaser who transmits a second earliest purchase confirmation response among the purchase confirmation purchasers.

When the payment is performed, the profit distribution unit may transmit an expected distribution order in which the purchasers who perform the payments are arranged in order according to the distribution way of the distribution profit to the terminals of the purchasers who perform the payments.

The expected distribution order may be made by arranging the purchasers who perform the payments in an order of payment.

The expected distribution order may be made by arranging the purchasers who perform the payments in an order of a cyber money amounts deposited into the cyber money account of the member account unit of the purchaser who performs the payment.

The expected distribution order may be made by arranging the purchasers who perform the payments in an order of a value obtained by multiplying the cyber money amount deposited into the cyber money accounts of the member account units of the purchasers who performs the payment and the number of the payments.

The expected distribution order is made by arranging the purchasers who perform the payments in an order of the purchase confirmation response of the purchaser who performs the payment with respect to the purchase confirmation request transmitted from the purchase confirmation management unit to the terminals of the purchasers who performs the payment.

A product sales promotion method according to an embodiment of the disclosed technology for allowing a product of a seller to be purchased by a purchaser through a product sales promotion system may include the steps of: (a) inputting at least one of a sales price of a product, a target period of time for product sales, a target amount of product sales to an event configuration unit through a terminal of the seller; (b) setting an event which is decided to be successful when the target amount of product sales is reached within the target period of time on the event configuration unit through the terminal of the seller, and inputting at least one of an amount of distribution profit to be distributed to a purchaser when the event is successful, a distribution way of the distribution profit, and a distribution rate of the distribution profit to the event configuration unit through the terminal of the seller; (c) activating the event through an event management unit; (d) performing a payment for the sales price of the product by the terminal of the purchaser through a product payment unit; (e) checking whether the number of payments for the sales price of the product received by the product payment unit reaches the target amount of product sales, through the event management unit; and (f) paying the distribution profit to the purchasers through a profit distribution unit when the event management unit decides that the event is successful.

The product sales promotion method may further include, before the step (c), the step of transmitting an event notification message for notifying a start date and a start time of the event activation to a terminal of the member joined in the product sales promotion system, through the event management unit.

The step (c) may include the step of activating the event after a predetermined standby period from a start time of the event activation, through the event management unit.

The product sales promotion method further includes, before or at the same time as the step (c), the step of transferring an event deposit of the seller which is the same amount as the distribution profit from the member account unit of the seller to a system account unit.

The product sales promotion method may further include, after the step (d), the step of depositing an amount made by the payment into the system account unit.

The product sales promotion method further includes, after the step (d), the step of transmitting a delivery address of the purchaser to the terminal of the seller through a delivery management unit.

The product sales promotion method may further include, after the step (d), the steps of: transmitting a purchase confirmation request to the terminal of the purchaser through a purchase confirmation management unit; receiving a response to the purchase confirmation request from the terminal of the purchaser through the purchase confirmation management unit; and when the response to the purchase confirmation request is a purchase cancel response, transferring an amount corresponding to the sales price into the member account unit of the purchaser.

The product sales promotion method may further include, after the step (d), the steps of: transmitting a purchase confirmation request to the terminal of the purchaser through a purchase confirmation management unit; and receiving a response to the purchase confirmation request from the terminal of the purchaser through the purchase confirmation management unit, and the step (f) includes the steps of: when the purchase confirmation management unit receives a purchase confirmation response and when the event management unit decides that the event is successful, determining an individual distribution profit to be distributed to a purchaser who transmits the purchase confirmation response (hereinafter, referred to as a “purchase confirmation purchaser”) by applying the distribution way of the distribution profit and the distribution rate of the distribution profit to the distribution profit, through the profit distribution unit; and transferring the individual distribution profit from an amount kept in a system account unit to the member account unit of the purchase confirmation purchaser through the profit distribution unit.

The distribution way of the distribution profit may include the steps of: arranging the purchase confirmation purchasers in an order of payment; paying a first individual distribution profit calculated by multiplying the distribution profit by the distribution rate of the distribution profit to a first purchase confirmation purchaser who performs an earliest payment among the purchase confirmation purchasers; and paying a second individual distribution profit calculated by multiplying an amount remained after subtracting the first individual distribution profit from the distribution profit by the distribution rate of the distribution profit to a second purchase confirmation purchaser who performs a second earliest payment among the purchase confirmation purchasers.

The distribution way of the distribution profit may include the steps of: arranging the purchase confirmation purchasers in an order of a cyber money amount deposited into the cyber money account of the purchase confirmation purchaser; paying a first individual distribution profit calculated by multiplying the distribution profit by the distribution rate of the distribution profit to a first purchase confirmation purchaser who has a largest cyber money amount among the purchase confirmation purchasers; and paying a second individual distribution profit calculated by multiplying an amount remained after subtracting the first individual distribution profit from the distribution profit by the distribution rate of the distribution profit to a second purchase confirmation purchaser who has a second largest cyber money amount among the purchase confirmation purchasers.

The distribution way of the distribution profit may include the steps of: arranging the purchase confirmation purchasers in an order of a value calculated by multiplying the cyber money amount of the cyber money account of the purchase confirmation purchaser by the number of the payments of the purchase confirmation purchaser (hereinafter, referred to as a “multiplied value for order”); paying a first individual distribution profit calculated by multiplying the distribution profit by the distribution rate of the distribution profit to a first purchase confirmation purchaser who has a largest multiplied value for order among the purchase confirmation purchasers; and paying a second individual distribution profit calculated by multiplying an amount remained after subtracting the first individual distribution profit from the distribution profit by the distribution rate of the distribution profit to a second purchase confirmation purchaser who has a second largest multiplied value for order among the purchase confirmation purchasers.

The distribution way of the distribution profit may include the steps of: arranging the purchase confirmation purchasers in an order of purchase confirmation response; paying a first individual distribution profit calculated by multiplying the distribution profit by the distribution rate of the distribution profit to a first purchase confirmation purchaser who transmits an earliest purchase confirmation response among the purchase confirmation purchasers; and paying a second individual distribution profit calculated by multiplying an amount remained after subtracting the first individual distribution profit from the distribution profit by the distribution rate of the distribution profit to a second purchase confirmation purchaser who transmits a second earliest purchase confirmation response among the purchase confirmation purchasers.

The step (d) may include the step of transmitting an expected distribution order in which the purchasers who perform the payments are arranged in order according to the distribution way of the distribution profit to the terminals of the purchasers who perform the payments, through the profit distribution unit when the payment is performed.

The expected distribution order may be made by arranging the purchasers who perform the payments in an order of payment.

The expected distribution order may be made by arranging the purchasers who perform the payments in an order of a cyber money amount deposited into the cyber money account of the member account unit of the purchaser who performs the payment.

The expected distribution order may be made by arranging the purchasers who perform the payment in an order of a value obtained by multiplying the cyber money amount deposited into the cyber money account of the member account unit of the purchaser who performs the payment by the number of the payments.

The expected distribution order may be made by arranging the purchasers who perform the payments in an order of the purchase confirmation response of the purchasers who perform the payments with respect to the purchase confirmation request transmitted from the purchase confirmation management unit to the terminals of the purchasers who perform the payments.

According to the embodiments of the disclosed technology, the product sales are promoted by distributing a portion of sales profit to the purchasers, under a condition that the product selling event defined by the seller is successful. According to the embodiments of the disclosed technology, because confirmation of purchase is demanded before distributing the distribution profit, refund after distributing the distribution profit is prevented.

As discussed above, the disclosed technology provides a significant improvement in promoting product sales.

### BRIEF DESCRIPTION OF THE DRAWINGS

FIG. 1 is an exemplary block diagram showing a configuration of a product sales promotion system according to an embodiment of the disclosed technology.

FIG. 2 is an exemplary flowchart showing processes of selling products and distributing a sales profit in the product sales promotion system according to an embodiment of the disclosed technology, wherein a purchaser makes a payment for a sales price on an event configured by a seller and performs a purchase confirmation response.

FIG. 3 is an exemplary flowchart showing processes of selling products and distributing a sales profit in the product sales promotion system according to an embodiment of the disclosed technology, wherein a purchaser makes a payment for a sales price on the event configured by the seller and performs a purchase cancel response.

### DETAILED DESCRIPTION

Hereinafter, a product sales promotion system and method according to an embodiment will now be described in detail with reference to the attached drawings. The embodiment is only an example of the invention. The features included in the embodiment are not necessarily essential to a solution of the invention. In describing the embodiment, an explanation of a well-known technology in the related art will be omitted for the brevity of the description.

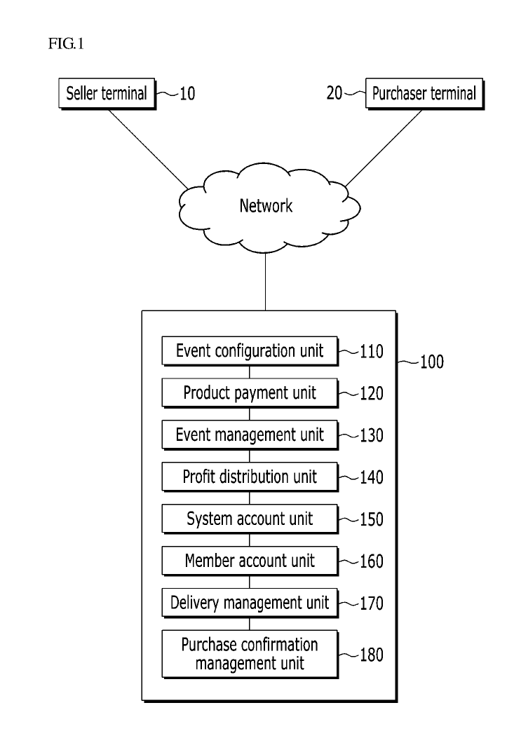

FIG. 1 is an exemplary block diagram showing a configuration of a product sales promotion system according to an embodiment of the disclosed technology.

A product sales promotion system 100 according to an embodiment of the disclosed technology may include an event configuration unit 110, a product payment unit 120, an event management unit 130, a profit distribution unit 140, a system account unit 150, a member account unit 160, a delivery management unit 170, and a purchase confirmation management unit 180.

The product sales promotion system 100 may be implemented with a microprocessor or a central processing unit (CPU), a storage device such as a volatile memory and/or a non-volatile memory, a communication device such as a modem, a network card, a Wi-Fi device, an infrared device, or a Bluetooth device, and peripheral devices. The respective units 110, 120, 130, 140, 150, 160, 170 and 180 of the product sales promotion system 100 may be implemented by one or more software installed in the storage device and operated by the microprocessor or a central processing unit (CPU). The respective units 110, 120, 130, 140, 150, 160, 170 and 180 of the product sales promotion system 100 may be implemented by one or more hardware respectively having a microprocessor or a central processing unit (CPU) and a storage device in which a software is installed. The product sales promotion system 100 may be implemented in one computer or a server, or may be implemented by a plurality of computers or servers distributed and linked to a communication network to provide communication between the distributed computers or servers.

The network provides data communication between the product sales promotion system 100 and the seller terminal 10 and the purchaser terminal 20. The network may be embodied in various types such as Internet, Local Area Network (LAN), Metropolitan Area Network (MAN), Wide Area Network (WAN) and etc.

A seller may be connected to the product sales promotion system 100 by using a seller terminal 10 through wired and/or wireless network. A purchaser may be connected to the product sales promotion system 100 by using a purchaser terminal 20 through the wired and/or wireless network. The seller terminal 10 and the purchaser terminal 20 may be devices for transmitting and receiving data to and from the product sales promotion system 100 connected thereto, and for example, desktop computers, laptops, smart phones, tablet computers, and so on may be used as the seller terminal 10 and the purchaser terminal 20. However, the seller terminal 10 and the purchaser terminal 20 are not limited to those mentioned above.

The seller and the purchaser may be members who join the product sales promotion system 100, and the members of the product sales promotion system 100 may have cyber money accounts and/or cash accounts connected to their own accounts. The cyber money accounts and/or the cash accounts may be included in the member account unit 160. The cyber money deposited into the cyber money accounts may be used as a distribution standard when a distribution profit as will be discussed later is distributed, and the distribution profit are put into the cyber money accounts in the form of cyber money. The cash in the cash accounts may be transferred to the cyber money accounts, exchanged with the cyber money in the ratio of 1:1 or in a predetermined ratio, and deposited into the cyber money accounts. Contrarily, the cyber money in the cyber money accounts may be transferred to the cash accounts, but in this case, desirably, a withdrawal fee at a given percentage for the transferring money has to be paid. The withdrawal fee may be transferred to the system account unit 150 of the product sales promotion system 100, and the cash may be transferred to the cash accounts of the members. The cyber money may be referred to as different names, for example, reward points, mileages, coupons, credits, gifts, incentives, energy currency, etc.

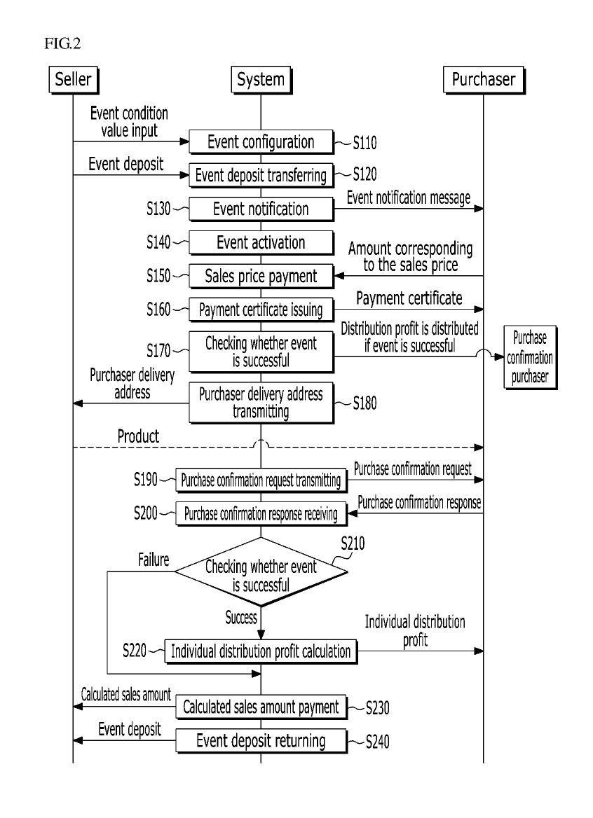

FIG. 2 is an exemplary flowchart showing the processes of selling products and distributing sales profit in the product sales promotion system according to an embodiment of the disclosed technology, wherein the purchaser makes a payment for a sales price on an event configured by the seller and performs a purchase confirmation response.

The seller is connected to the product sales promotion system 100 by using the seller terminal 10, and he or she selects an event configuration menu so as to set an event to be successful when a target amount of product sales is reached within a target period of time for product sales. The event configuration unit 110 displays, on the seller terminal 10, an input screen where, as event condition values, the sales price of a product, the target period of time for product sales, the target amount of product sales, distribution profit to be distributed to the purchasers performing purchase confirmation responses if the event is successful, a distribution way of the distribution profit, and a distribution rate of the distribution profit are inputted, and the seller inputs, on the seller's terminal 10, the sales price of the product to be sold through the product sales promotion system 100, the target period of time for product sales, the target amount of product sales, the distribution profit, the distribution way of the distribution profit, and the distribution rate of the distribution profit. The values inputted to the event configuration unit 110 through the seller terminal 10 are stored in the event configuration unit 110, thereby completing setting the event (at step S110).

If the payment for the sales price of the product is made, a payment certificate is issued by the event management unit 130, and if the number of payment certificates reaches the target amount of product sales, it is considered that the event is successful.

The sales price of the product, the target period of time of product sales, the target amount of product sales, distribution profit, the distribution way of the distribution profit, and the distribution rate of the distribution profit may be arbitrarily determined by the seller, and some of them may be suggested with appropriate values by means of the product sales promotion system 100. Further, some of them may be in advance calculated as optimized values by means of the product sales promotion system 100 and provided as fixed values.

The event management unit 130 transmits, a message that the amount corresponding to the distribution profit, as the event deposit, must be deposited into the system account unit 150, to the seller terminal 10. Through the seller terminal 10, the seller requests the event management unit 130 to transfer the event deposit having the same amount as the distribution profit from the cyber money account and/or cash account connected to the seller's account to the system account unit 150, and the event management unit 130 transfers the event deposit from the cyber money account and/or cash account of the seller to the system account unit 150 (at step S120). The cash may be transferred to the system account unit 150, and in case where the cash is transferred as the event deposit from the cyber money account to the system account unit 150, the withdrawal fee may occur so that the amount corresponding to the event deposit and the withdrawal fee may be withdrawn from the cyber money account.

Before the event is activated, the event management unit 130 may transmit an event notification message of notifying the members joined in the product sales promotion system 100 of the start date and start time of the event activation to the terminals of the members (at step S130). As the start date and start time of the event activation are in advance notified, the number of momentary concurrent users for the product sales promotion system 100 can be significantly increased. The event notification message that notifies the members of the event activation can ensure fair sales in case where the distribution way of the distribution profit is determined according to the order of payment (that is, the payment certificate issue order), the order of sales price payment, or the order of purchase confirmation response. As a result, the event notification message can prevent the first occupation in the distribution order of the distribution profit by the purchasers who in advance obtain the event information.

Before the activation of the event, further, the event management unit 130 may notify the members of a period of time during which it is possible to start the event, and it is possible to unexpectedly start the activation of the event within the period of time. In detail, the event management unit 130 may notify the members of a period of time during which it is possible to start the event, for example, between May 1, 2016 and May 8, 2106, and without any additional notification, the event may be activated on May 3, 2016, 1 μm.

The event management unit 130 may activate the event configured through the event configuration unit 110 by the seller terminal 10 of the seller (at step S140). Before the event is activated by the seller, the event management unit 130 may request the seller terminal 10 to deposit a system usage fee, and if it is checked that the system usage fee is deposited into the system account unit 150, the event management unit 130 may activate the event.

In the state where the event notification message is not sent to the members joined in the product sales promotion system 100 before the activation of the event, it is possible that the event is activated on the start date and time of the event, without any notification.

The event management unit 130 may activate the event after a predetermined standby period from the start time of the event, not on the start time of the event set in the event configuration unit 110 through the seller terminal 10 of the seller. In case where the distribution way of the distribution profit is determined according to the order of payment (that is, the payment certificate issue order), the order of sales price payment, or the order of purchase confirmation response, accordingly, fair sales can be ensured. For the predetermined standby period, in detail, the members can obtain the event information, thereby preventing the first occupation in the distribution order of the distribution profit by the purchasers who in advance obtain the event information.

If the event is activated through the event management unit 130 (at the step S140), the product may be purchased through the purchaser terminal 20 of the purchaser.

So as to purchase the product, the purchaser makes a payment for the sales price on the payment screen provided through the product payment unit 120 by the purchaser terminal 20, and the product payment unit 120 deposits the paid amount for the sales price into the system account unit 150 (at step S150). The paid amount for the sales price may be the cash and/or cyber money withdrawn from the cyber money account and/or cash account of the purchaser, card sales amount received from a credit card company of the purchaser, and payment amount received from a smart phone communication company of the purchaser. The payment ways include known online payment ways, and a detailed explanation on the payment ways will be omitted.

If the payment for the sales price is made, the event management unit 130 may issue the payment certificate and may transmit the payment certificate to the purchaser terminal 20 (at step S160).

Whenever the event management unit 130 issues the payment certificates for the respective purchasers, it checks whether the event is successful (at step S170). The event management unit 130 may check whether the target amount of product sales is reached by the purchase of the purchaser who makes payment for the guaranteed amount. If it is checked that the event is successful by the purchase of the purchaser who makes payment for the sales price, the distribution profit starts to be distributed to the other purchasers who have purchased the products, have performed the purchase confirmation responses, and have been waiting for the event success.

The delivery management unit 170 may transmit a delivery address and a payment certificate of the purchaser who makes a payment for the sale price to the seller terminal 10 to allow the seller to deliver the product to the purchaser (at step S180). A delivery way may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 180 may transmit the purchase confirmation request to the purchaser who receives the product through the delivery service or directly receives the product from the seller (at step S190).

The purchase confirmation management unit 180 may receive the response to the purchase confirmation request from the purchaser (at step S200). The response to the purchase confirmation request is either the purchase confirmation response or the purchase cancel response. Hereinafter, an explanation on the case where the response to the purchase confirmation request is the purchase confirmation response will be given.

If the purchase confirmation management unit 180 receives the purchase confirmation response from the purchaser, the event management unit 130 may check whether the event is successful (at step S210). If the event management unit 130 checks that the number of payment certificates issued by the payments for the products reaches the target amount of product sales, it is determined that the event is successful, and the profit distribution unit 140 may pay an individual distribution profit calculated from the distribution profit, in cyber money, to the purchaser who performs the purchase confirmation response (at step S220). The profit distribution unit 140 may apply the distribution way of the distribution profit and the distribution rate of the distribution profit to the distribution profit to calculate the individual distribution profit. The individual distribution profit may be withdrawn from the amount kept in the system account unit 150 and may be transferred to the cyber money account of the purchaser who performs the purchase confirmation response. The distribution profit is paid in cyber money, but it is possible that the distribution profit is transferred, in cash, to the cash account of the purchaser who performs the purchase confirmation response.

After the individual distribution profit is paid through the profit distribution unit 140 (at the step S220), the event management unit 130 may transfer the sales amount calculated by subtracting the sum of the paid individual distribution profits from the total sales amount (calculated by multiplying the sales price by the number of purchase confirmed products) to the cyber money account and/or the cash account of the seller (at step S230) and may return the event deposit in the system account unit 150 to the cyber money account and/or the cash account of the seller (at step S240). In this case, an explanation on S210, S220, S230 and S240 which are sequentially performed is paid, but the steps may be performed concurrently or in a reverse order to each other.

If the event management unit 130 checks that the number of payment certificates issued by the payments for the products does not reach the target amount of product sales (at the step S210), it is determined that the event fails. If the event fails, the step of distributing the individual distribution profit (at the step S220) is not performed.

If the event fails, the event management unit 130 may transfer the total sales amount (calculated by multiplying the sales price by the number of purchase confirmed products) to the cyber money account and/or the cash account of the seller (at the step S230) and may return the event deposit in the system account unit 150 to the cyber money account and/or the cash account of the seller (at the step S240). In this case, an explanation on the steps S210, S230 and S240 which are sequentially performed is paid, but the steps may be performed concurrently or in a reverse order to each other.

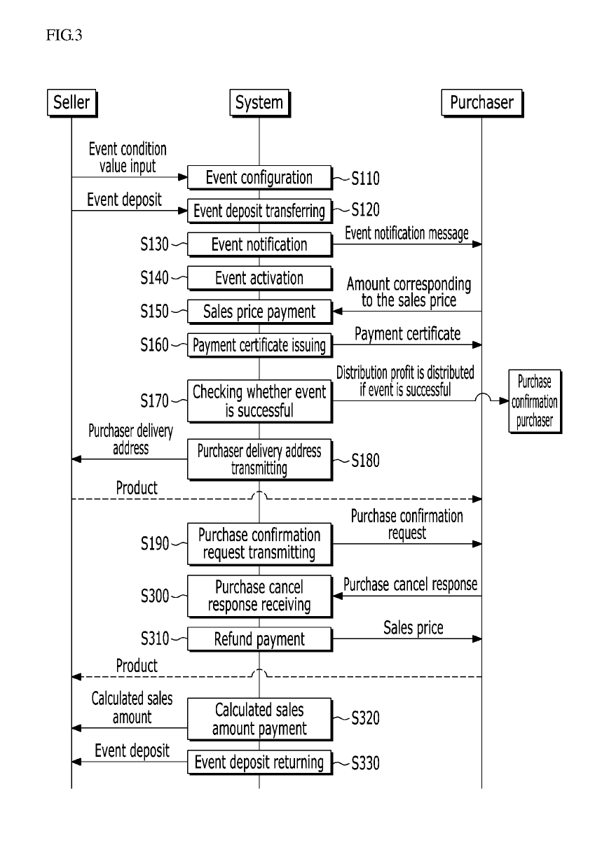

FIG. 3 is an exemplary flowchart showing the case where the purchase confirmation management unit 180 at the step S220 of FIG. 2 receives the purchase cancel response from the purchaser, wherein since the steps S110 to S190 are the same as those of FIG. 2, an explanation on them will be omitted, and accordingly, the step S200 of FIG. 2 (corresponding to step S300 of FIG. 3) and the steps after the step S230 will be explained in detail.

The purchase confirmation management unit 180 may transmit the purchase confirmation request to the purchaser (at the step S190).

The purchase confirmation management unit 180 may receive the response to the purchase confirmation request from the purchaser (at the step S300). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund in case where the purchased product is unsatisfied.

If the purchase confirmation management unit 180 receives the purchase cancel response from the purchaser (at step S300), the profit distribution unit 140 pays the amount corresponding to the sales price, as a refund, to the purchaser who performs the purchase cancel response (at step S310). The refund may be withdrawn from the amount kept in the system account unit 150 and thus may be transferred to the cyber money account and/or the cash account of the purchaser who performs the purchase cancel response.

After the profit distribution unit 140 pays the individual distribution profits to the purchasers who perform the purchase confirmation response, the event management unit 130 may transfer the sales amount calculated by subtracting the sum of the paid individual distribution profits from the total sales amount (calculated by multiplying the sales price by the number of purchase confirmed products) to the cyber money account and/or the cash account of the seller (at step S320) and may return the event deposit in the system account unit 150 to the cyber money account and/or the cash account of the seller (at step S330).

An expected distribution order in the product sales promotion system and method according to an embodiment of the disclosed technology may be calculated before the purchase confirmation responses of the purchasers are completed. Whenever the payment certificates are issued by the event management unit 130, the profit distribution unit 140 may calculate an expected distribution order of the purchasers in real time to transmit the real time expected distribution order to the terminals 20 of the purchasers.

In this case, of course, the profit distribution unit 140 may not publish the real time expected distribution order until the event is successful, and after the event is successful, the profit distribution unit 140 may transmit the real time expected distribution order to the terminals 20 of the purchasers. Until the event is successful, as a result, the purchasers cannot obtain the information on their real time expected distribution order, so that such uncertainty in the real time expected distribution order makes purchase desires more stimulated, thereby allowing the event to be successful within a shorter period of time.

The distribution way of the distribution profit in the product sales promotion system and method according to an embodiment of the disclosed technology may be selected by the seller. For example, the distribution way of the distribution profit may be determined according to the order of payment (that is, the payment certificate issue order), an amount of cyber money retained, or the order of purchase confirmation response.

The distribution way of the distribution profit according to the order of payment may be carried out by arranging purchasers who transmit the purchase confirmation responses (hereinafter, referred to as “purchase confirmation purchasers”) in the order of payment. First, a first individual distribution profit calculated by multiplying the distribution profit by a distribution rate may be paid to a first purchase confirmation purchaser who performs the earliest payment among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who performs the payment in the second earliest among the purchase confirmation purchasers.

The distribution way of the distribution profit according to the amount of cyber money retained may be carried out by arranging the purchase confirmation purchasers in the order of the cyber money amount of the cyber money account allocated to the account of the purchase confirmation purchaser. In this case, the cyber money deposited into the cyber money account may include the cyber money exchanged from the cash of the purchase confirmation purchaser, and the cyber money deposited as distribution profit transferred from other events. Next, a first individual distribution profit calculated by multiplying the distribution profit by the distribution rate of the distribution profit is paid to a first purchase confirmation purchaser who has the largest cyber money amount among the purchase confirmation purchasers, and a second individual distribution profit calculated by multiplying the amount remained after subtracting the first individual distribution profit from the distribution profit by the distribution rate of the distribution profit is paid to a second purchase confirmation purchaser who has the second largest cyber money amount among the purchase confirmation purchasers.

The distribution way of the distribution profit according to the amount of cyber money retained may be carried out on the basis of the number of the payments of the purchase confirmation purchasers. The distribution way may be carried out by arranging the purchase confirmation purchasers in the order of a value calculated by multiplying the cyber money amount of the cyber money accounts included in the account of the purchase confirmation purchaser by the number of payment certifications issued to the purchase confirmation purchaser (hereinafter, referred to as a “multiplied value for order”). In this case, the cyber money deposited into the cyber money account may include the cyber money exchanged from the cash of the purchase confirmation purchaser, the cyber money deposited as distribution profit transferred from other events, and the cyber money generated by activities of the member joined in the product sales promotion system 100. Then, a first individual distribution profit calculated by multiplying the distribution profit by the distribution rate of the distribution profit may be paid to a first purchase confirmation purchaser who has the largest multiplied value for order among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who has the second largest multiplied value for order among the purchase confirmation purchasers. For example, if one purchase confirmation purchaser receives five payment certificates, the multiplied value for order of the purchase confirmation purchaser is calculated as the amount of cyber money retained*5.

The distribution way of the distribution profit according to the order of purchase confirmation response may be carried out by arranging the purchase confirmation purchasers in the order of purchase confirmation response. First, a first individual distribution profit calculated by multiplying the distribution profit by the distribution rate of the distribution profit may be paid to a first purchase confirmation purchaser who transmits the earliest purchase confirmation response among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who transmits the second earliest purchase confirmation response among the purchase confirmation purchasers.

In the distribution ways of the distribution profit as mentioned above, examples only for the first and second purchase confirmation purchasers are suggested, but in the same manner as above, individual distribution profits may be paid to the purchase confirmation purchasers in the post-order. For example, a third individual distribution profit calculated by multiplying the amount remained after subtracting the first individual distribution profit and the second individual distribution profit from the distribution profit by the distribution rate of the distribution profit may be paid to a third purchase confirmation purchaser.

If the distribution profit remains after the individual distribution profits are paid to all of the purchase confirmation purchasers, another first individual distribution profit calculated by multiplying the remaining distribution profit by the distribution rate of the distribution profit may be paid to the first purchase confirmation purchasers again and then the distribution of the remaining distribution profit may proceed in the same manner as above. If the remaining distribution profit is less than a predetermined amount, however, the profit distribution unit 140 may transfer the remaining distribution profit to the system account unit 150 and may finish the distribution of the distribution profit.

Now, an explanation on the effects obtained by the product sales promotion system and method according to an embodiment of the disclosed technology will be given with a given example.

One sales agency of a computer manufacturing company A sells a laptop computer X at a retail price of 2,000 dollars. The average number of laptop computers X sold for a month in the sales agency is 50. Actually, the laptop computer is sold at the lowest price of 1,800 dollars on on-line markets. The sales agency determines that they sell the laptop computer X at the lowest price of 1,800 dollars through the product sales promotion system according to an embodiment of the disclosed technology, and the event is set with the following conditions.
Sales price: 1,800 dollars
Target period of time for product sales: one month
Target amount of product sales: 2,000
Distribution profit to be distributed to purchasers if the event is successful: 780,000 dollars
Distribution way of the distribution profit: distribution according to cyber money amounts retained in the cyber money accounts of purchase confirmation purchasers
Distribution rate of the distribution profit: 0.1%

For only one month, the sales volume of the laptop computers increases 40 times higher than the sales volume for the past one month. Therefore, the sales agency can obtain additional cash of 3,510,000 dollars (=1,800 dollars*1,950). If the sales agency sold the laptop computers in a conventional manner, it would take three years and three months to sell the 1,950 laptop computers. The sales agency decides to distribute the additional profit of 780,000 dollars corresponding to about 22% of the additional cash to the purchasers.

Purchaser B is a first purchaser having the largest cyber money amount among 2,000 purchasers, Purchaser C is a second purchaser having the second largest cyber money amount among the purchasers, Purchaser D is a 500th purchaser having the 500th largest cyber money amount among the purchasers, and Purchaser E is a 2000th purchaser having the 2000th largest cyber money amount among the purchasers. In this case, the cyber money to be distributed to Purchasers B, C, D and E will be calculated as follows.

Individual distribution profit of 780 dollars[=distribution profit of 780,000 dollars*distribution rate of 0.1%] [Amount to be paid to Purchaser B]

Individual distribution profit of 779 dollars[=(amount of 779,220 dollars calculated by subtracting the first individual distribution profit of 780 dollars from distribution profit of 780,000 dollars)*(distribution rate of 0.1%)] [Amount to be paid to Purchaser C]

Individual distribution profit of 473 dollars[=(amount of 473,449 dollars calculated by subtracting the individual distribution profits of up to 499th purchasers from distribution profit of 780,000 dollars)*(distribution rate of 0.1%)] [Amount to be paid to Purchaser D]

Individual distribution profit of 106 dollars [(=amount of 105,562 dollars calculated by subtracting the individual distribution profits of up to 1999th purchasers from distribution profit of 780,000 dollars)*(distribution rate of 0.1%)] [Amount to be paid to Purchaser E]

Purchasers B, C, D and E purchase the laptop computer X of 1,800 dollars, which is the same price as the lowest price sold on on-line markets. According to the event success, furthermore, Purchasers B, C, D and E have got the respective individual distribution profits of 780 dollars, 779 dollars, 473 dollars, and 106 dollars in the form of cyber money. With a payment of the withdrawal fee, the cyber money in the cyber money account may be transferred to the cash account or cash may be withdrawn directly from the cyber money account, thereby increasing the cash assets of the purchaser. Further, since the order of the cyber money retention of the purchaser is raised by the cyber money distributed through this purchase, a larger amount of individual distribution profit may be distributed to the purchaser at the time of next purchase.

If the payment of the purchaser is made through the use of an interest-free installment program provided by a credit card company, the profit of the purchaser will be maximized. If the purchaser buys a 2,000 dollar laptop computer in a conventional purchase system, he or she just prepares 2,000 dollars, which makes him or her feel burdened so that he or she does not purchase the laptop computer. Through the product sales promotion system 200, the sales price is paid in interest-free installments, and next, the installment amount is paid with the individual distribution profit, thereby making the purchase burden of the purchase disappear. Such an advantage is obtained because the value of time is turned into the cyber money. Particularly, if the distribution rate of the distribution profit is raised by the seller, the amount of the distribution profit to be distributed to the top-order purchasers is increased, so that the consumption willingness and event join willingness of the members become high. An example of such a case will be explained later.

For a short period of time, of course, the seller accomplishes a significantly larger amount of sales than an amount of sales in the past, thereby obtaining a great sales profit, and even if the distribution profit is distributed, an amount of sales over several months to years can be obtained within the short period of time, so that no financial loss occurs. So as to improve the possibility of event success, further, if the distribution profit or the distribution rate of the distribution profit is raised by the seller, the event join desires of the members can be strongly stimulated, thereby rapidly and reliably achieving the target amount of product sales.

The product sales promotion system 100 can obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment can be conducted by means of the use of the system usage fees, the withdrawal fees, and the cash balance in the system account, thereby creating great profits.

The members may withdraw the cyber money from their cyber money accounts and encash the cyber money, or they may get a loan against their cyber money from the product sales promotion system 100. The members can encash their cyber money with a payment of the withdrawal fees, but in this case, an amount of cyber money retained in the cyber money account is decreased to cause the distribution order of the event to be undesirably lowered. So as to perform the encashing of the cyber money in the state where the amount of cyber money retained is kept, accordingly, the product sales promotion system 100 may lend cash to the members with their cyber money as collateral. As a result, the product sales promotion system 100 may do a financial business.

Now, an explanation on more improved effects obtained by increasing the distribution profit and the distribution rate of the distribution profit through the seller in the product sales promotion system 100 and method according to an embodiment of the disclosed technology will be given with a given example.

A famous fitness center A sells a three-year membership X at a retail price of 3,000 dollars. The maximum number of three-year memberships X sold for a day in the fitness center A is 10. Actually, the three-year membership X is sold at the lowest price of 2,800 dollars on on-line markets, and the sales profit obtained when one three-year membership X is sold at the fitness center A is 1,650 dollars.

The fitness center A determines that they sell the three-year membership X at the lowest price of 2,800 dollars through the product sales promotion system according to an embodiment of the disclosed technology, and the event is set with the following conditions.
Sales price: 2,800 dollars
Target period of time for product sales: one day
Target amount of product sales: 1,000
Distribution profit to be distributed to purchasers if the event is successful: 1,300,000 dollars
Distribution way of the distribution profit: distribution according to payment order of purchase confirmation purchasers
Distribution rate of the distribution profit: 0.6%

For only one day, the sales volume of the three-year membership increases 100 times higher than the sales volume for the past one day. Therefore, the fitness center can obtain additional cash of 2,772,000 dollars (=2,800 dollars*990) and obtain additional sales profit of 1,633,500 dollars (=1,650 dollars*990). If the fitness center sold the three-year membership in a conventional manner, it would take at least three months to sell the 990 three-year memberships, and the 990 three-year memberships could not be ensured. The fitness center decides to distribute the additional profit of 1,300,000 dollars corresponding to 78% of the additional sales profit to the purchasers. Purchaser B is a first purchaser who is in the first payment order among the 1,000 purchasers, Purchaser C is in the second payment order, Purchaser D is in the 500th payment order, and Purchaser E is in the 1,000th payment order. In this case, the cyber money to be distributed to Purchasers B, C, D and E will be calculated as follows.

Individual distribution profit of 7,800 dollars[=distribution profit of 1,300,000 dollars*distribution rate of 0.6%)] [Amount to be paid to Purchaser B]

Individual distribution profit of 7,753 dollars[=(amount of 1,292,200 dollars calculated by subtracting the first individual distribution profit of 7,800 dollars from distribution profit of 1,300,000 dollars)*(distribution rate of 0.6%)] [Amount to be paid to purchaser C]

Individual distribution profit of 387 dollars[=(amount of 64,528 dollars calculated by subtracting the individual distribution profits of up to 499th purchasers from distribution profit of 1,300,000 dollars)*(distribution rate of 0.6%)] [Amount to be paid to purchaser D]

Individual distribution profit of 19 dollars[=(amount of 3,184 dollars calculated by subtracting the individual distribution profits of up to 999th purchasers from distribution profit of 1,300,000 dollars)*(distribution rate of 0.6%)] [Amount to be paid to purchaser E]

Purchasers B, C, D and E purchase the three-year membership of 2,800 dollars, which is the same price as the lowest price sold on on-line markets. According to the event success, furthermore, Purchasers B, C, D and E have got the respective individual distribution profits of 7,800 dollars, 7,753 dollars, 387 dollars, and 19 dollars in the form of cyber money.

With a payment of the withdrawal fee, the cyber money in the cyber money account may be transferred to the cash account or cash may be withdrawn directly from the cyber money account, thereby increasing the cash assets of the purchaser. Further, Purchasers B and C who are in the first and second distribution order can earn a great amount of money, which is more than the price of the three-year membership. Their wealth is increased through their consumption.

Through the two examples as mentioned above, it can be appreciated that the product sales promotion system according to an embodiment of the disclosed technology provides a consuming-tech (consumption+financial technology) system that increases wealth through consumption, and as large consumption is made, wealth is increased, so that consumption, deal and turnover ratio are optimized to achieve the advancement into a new economic paradigm unlike the conventional economic paradigm.

While the disclosed technology has been described with reference to the particular illustrative embodiments, it is not to be restricted by the embodiments but only by the appended claims. It is to be appreciated that those skilled in the art can change or modify the embodiments without departing from the scope and spirit of the disclosed technology.

### EXPLANATION ON REFERENCE NUMERALS

10: seller terminal
20: purchaser terminal
100: product sales promotion system
110: event configuration unit
120: product payment unit
130: event management unit
140: profit distribution unit
150: system account unit
160: member account unit
170: delivery management unit
180: purchase confirmation management unit

What is claimed is:

1. A product sales promotion system comprising:
an event configuration unit adapted to receive at least one of sales price of a product, a target period of time for product sales and a target amount of product sales from a terminal of a seller, to set an event which is decided to be successful when the target amount of product sales is reached within the target period of time according to an input from the terminal of the seller, and to receive at least one of an amount of a distribution profit to be distributed to a purchaser when the event is successful, a distribution way of the distribution profit, and a distribution rate of the distribution profit from the terminal of the seller;
a product payment unit adapted to receive a payment for the sales price of the product from a terminal of the purchaser;
an event management unit adapted to activate the event and to check whether the number of payments for the sales price of the product received by the product payment unit reaches the target amount of product sales; and
a profit distribution unit adapted to pay the distribution profit to the purchaser when the event management unit decides that the event is successful.

2. The product sales promotion system according to claim 1, wherein before the event is activated, the event management unit transmits an event notification message for notifying a start date and a start time of the event activation to a terminal of a member joined in the product sales promotion system.

3. The product sales promotion system according to claim 1, wherein the event management unit activates the event after a predetermined standby period from a start time of the event activation.

4. The product sales promotion system according to claim 1, further comprising:
a system account unit adapted to deposit an amount given by the payments; and
a member account unit allocated to the member joined in the product sales promotion system, the member account unit adapted to deposit at least one of cyber money and cash.

5. The product sales promotion system according to claim 4, wherein before or at the same time as the event activation starts, an event deposit of the seller which is the same amount as the distribution profit is transferred from the member account unit of the seller to the system account unit.

6. The product sales promotion system according to claim 1, further comprising a delivery management unit adapted to transmit a delivery address of the purchaser to the terminal of the seller.

7. The product sales promotion system according to claim 4, further comprising a purchase confirmation management unit adapted to transmit a purchase confirmation request to the terminal of the purchaser and to receive a response to the purchase confirmation request from the terminal of the purchaser, wherein when the response to the purchase confirmation request is a purchase cancel response, the profit distribution unit transfers an amount corresponding to the sales price to the member account unit of the purchaser.

8. The product sales promotion system according to claim 4, further comprising a purchase confirmation management unit adapted to transmit a purchase confirmation request to the terminal of the purchaser and to receive a response to the purchase confirmation request from the terminal of the purchaser,
wherein when the purchase confirmation management unit receives a purchase confirmation response and the event management unit decides that the event is successful, the profit distribution unit determines an individual distribution profit to be distributed to a purchaser who transmits the purchase confirmation response (hereinafter, referred to as a “purchase confirmation purchaser”) by applying the distribution way of the distribution profit and the distribution rate of the distribution profit to the distribution profit, and the profit distribution unit transfers the individual distribution profit from an amount kept in the system account unit to the member account unit of the purchase confirmation purchaser.

9. The product sales promotion system according to claim 8, wherein the distribution way of the distribution profit comprises:
arranging the purchase confirmation purchasers in an order of payment;
paying a first individual distribution profit calculated by multiplying the distribution profit by the distribution rate of the distribution profit to a first purchase confirmation purchaser who performs an earliest payment among the purchase confirmation purchasers; and
paying a second individual distribution profit calculated by multiplying an amount remained after subtracting the first individual distribution profit from the distribution profit by the distribution rate of the distribution profit to a second purchase confirmation purchaser who performs a second earliest payment among the purchase confirmation purchasers.

10. The product sales promotion system according to claim 8, wherein the member account unit comprises a cyber money account into which cyber money is deposited, and
wherein the distribution way of the distribution profit comprises:
arranging the purchase confirmation purchasers in an order of cyber money amount deposited into the cyber money account of the purchase confirmation purchaser;
paying a first individual distribution profit calculated by multiplying the distribution profit by the distribution rate of the distribution profit to a first purchase confirmation purchaser who has a largest cyber money amount among the purchase confirmation purchasers; and
paying a second individual distribution profit calculated by multiplying an amount remained after subtracting the first individual distribution profit from the distribution profit by the distribution rate of the distribution profit to a second purchase confirmation purchaser who has a second largest cyber money amount among the purchase confirmation purchasers.

11. The product sales promotion system according to claim 8, wherein the member account unit comprises a cyber money account into which cyber money is deposited, and
wherein the distribution way of the distribution profit comprises:
arranging the purchase confirmation purchasers in an order of a value calculated by multiplying the cyber money amount of the cyber money account of the purchase confirmation purchaser by the number of the payments of the purchase confirmation purchaser (hereinafter, referred to as a “multiplied value for order”);
paying a first individual distribution profit calculated by multiplying the distribution profit by the distribution rate of the distribution profit to a first purchase confirmation purchaser who has a largest multiplied value for order among the purchase confirmation purchasers; and
paying a second individual distribution profit calculated by multiplying an amount remained after subtracting the first individual distribution profit from the distribution profit by the distribution rate of the distribution profit to a second purchase confirmation purchaser who has a second largest multiplied value for order among the purchase confirmation purchasers.

12. The product sales promotion system according to claim 8, wherein the distribution way of the distribution profit comprises:
arranging the purchase confirmation purchasers in an order of purchase confirmation response;
paying a first individual distribution profit calculated by multiplying the distribution profit by the distribution rate of the distribution profit to a first purchase confirmation purchaser who transmits an earliest purchase confirmation response among the purchase confirmation purchasers; and
paying a second individual distribution profit calculated by multiplying an amount remained after subtracting the first individual distribution profit from the distribution profit by the distribution rate of the distribution profit to a second purchase confirmation purchaser who transmits a second earliest purchase confirmation response among the purchase confirmation purchasers.

13. The product sales promotion system according to claim 4, wherein when the payment is performed, the profit distribution unit transmits an expected distribution order in which the purchasers who perform the payments are arranged in order according to the distribution way of the distribution profit to the terminals of the purchasers who perform the payments.

14. The product sales promotion system according to claim 13, wherein the expected distribution order is made by arranging the purchasers who perform the payments in an order of payment.

15. The product sales promotion system according to claim 13, wherein the expected distribution order is made by arranging the purchasers who perform the payments in an order of a cyber money amount deposited into the cyber money account of the member account unit of the purchaser who performs the payment.

16. The product sales promotion system according to claim 13, wherein the expected distribution order is made by arranging the purchasers who perform the payments in an order of a value obtained by multiplying the cyber money amount deposited into the cyber money account of the member account unit of the purchaser who performs the payment and the number of the payments.

17. The product sales promotion system according to claim 13, wherein the expected distribution order is made by arranging the purchasers who perform the payments in an order of the purchase confirmation response of the purchaser who performs the payment with respect to the purchase confirmation request transmitted from the purchase confirmation management unit to the terminal of the purchaser who performs the payment.
